(19) United States
(12) Patent Application Publication
(10) Pub. No.: US 2023/0205512 A1
(43) Pub. Date: Jun. 29, 2023

(54) SYSTEM UPDATING METHOD AND ELECTRONIC APPARATUS

(71) Applicant: QNAP SYSTEMS, INC., New Taipei City (TW)

(72) Inventors: Yi-Chun Chen, New Taipei City (TW); Yi-Chun Chou, New Taipei City (TW)

(73) Assignee: QNAP SYSTEMS, INC., New Taipei City (TW)

(21) Appl. No.: 17/844,740

(22) Filed: Jun. 21, 2022

(30) Foreign Application Priority Data
Dec. 29, 2021 (TW) 110149270

(51) Int. Cl. G06F 8/65; G06F 8/61

(52) U.S. Cl. CPC G06F 8/65; G06F 8/61

(57) ABSTRACT

A system updating method and an electronic apparatus are provided. The electronic apparatus operates a first operating system (OS). In the method, an installation program is downloaded through an updater. The installation program includes one or more installation parameter used for an installation operation of target firmware. The target firmware includes a second OS. The installation operation is performed through the updater with the installation program according to the installation parameter provided by the installation program, to replace the first OS with the second OS. The installation program calls one or more function operated in the first OS and provided by the updater according to the installation parameter. Accordingly, the device utilization, installation efficiency, and installation flexibility may be increased.

### CROSS-REFERENCE TO RELATED APPLICATION

This application claims the priority benefit of Taiwan application serial no. 110149270, filed on Dec. 29, 2021. The entirety of the above-mentioned patent application is hereby incorporated by reference herein and made a part of this specification.

### BACKGROUND

### Technical Field

The disclosure relates to a system update, and in particular, to a system updating method and an electronic apparatus.

### Description of Related Art

An operating system (OS) is system software that manages computer hardware and software resources and provides common services for computer programs. For example, Windows, macOS, or Linux. In addition, firmware is software embedded into a hardware device. The firmware consists of a set of instructions to control hardware behaviors. It is worth noting that the firmware may include the operating system. If the latest operating system version is released, a firmware upgrade is required to upgrade the existing version to the latest version.

In addition, cloud computing continues accelerating digital transformation and innovation in many fields (e.g., mobile communication, robotics, and Internet of Things (IoT)). However, to deploy a cloud service like infrastructure as a service (IaaS), platform as a service (PaaS), or software as a service (SaaS), it is required to set up different types of specified hardware and the firmware (including the operating system). For example, many special-purpose devices for hypervisor tasking, storage, network and, computing have to be prepared. There is dependency between hardware and the operating system or between a software service and the operating system, leading to low utilization of the device. For example, FIG. 1A is a schematic diagram of an example illustrating cloud service deployment. Referring to FIG. 1A, the utilization of a device 2 and the utilization of a device 3 are relatively low. FIG. 1B is a schematic diagram of another example illustrating cloud service deployment. Referring to FIG. 1A and FIG. 1B, the device 1 has higher computing power than device2 and device3. the utilization of a device 2 and the utilization of a device 3 are relatively low. To increase the utilization, it is necessary to provide a solution to switching the operating system on the device.

### SUMMARY

Accordingly, the disclosure is directed to a system updating method and an electronic apparatus capable of flexibly replacing an operating system.

A system updating method of the embodiment of the disclosure is adapted to an electronic apparatus. The electronic apparatus operates a first operating system. The system updating method includes, but not limited to, the following. An installation program is downloaded through an updater. The installation program includes one or more installation parameter used for an installation operation of target firmware, and the target firmware includes a second operating system. The installation operation is performed through the updater with the installation program according to the installation parameter provided by the installation program to replace the first operating system with the second operating system. The installation program calls one or more function operated in the first operating system and provided by the updater according to a corresponding installation parameter.

An electronic apparatus of the embodiment of the disclosure operates a first operating system. The electronic apparatus includes, but not limited to, a communication transceiver, a memory, one or more storage device, and a processor. The communication transceiver is configured to transmit or receive a signal. The memory is configured to store a program code. The storage device is configured to store a first operating system. The processor is coupled to the communication transceiver, the storage device, and the memory. The processor is configured to load and execute the program code to download an installation program through an updater by using the transceiver and perform the installation operation through the updater with the installation program according to one or more installation parameter provided by the installation program to replace the first operating system stored in the storage device with a second operating system. The installation program calls one or more function operated in the first operating system and provided by the updater according to a corresponding installation parameter. The installation program includes the one or more installation parameter used for the installation operation of target firmware, and the target firmware includes the second operating system.

Based on the above, according to the system updating method and the electronic apparatus of the embodiments of the disclosure, a software component updater is provided to download the installation program and complete the installation operation of a specific operating system with the installation program, thereby increasing the flexibility of a system update.

In order to make the aforementioned features and advantages of the disclosure comprehensible, embodiments accompanied with drawings are described in detail below.

### BRIEF DESCRIPTION OF THE DRAWINGS

FIG. 1A is a schematic diagram of an example illustrating cloud service deployment.

FIG. 1B is a schematic diagram of another example illustrating cloud service deployment.

FIG. 2 is a block diagram of elements of a system according to an embodiment of the disclosure.

FIG. 3 is a schematic diagram of a firmware grade procedure according to an embodiment of the disclosure.

FIG. 4 is a flowchart of a system updating method according to an embodiment of the disclosure.

FIG. 5A and FIG. 5B are schematic diagrams illustrating a download of an installation program according to an embodiment of the disclosure.

FIG. 6 is a schematic diagram of workflows and basic application programing interfaces (API) according to an embodiment of the disclosure.

FIG. 7 is a flowchart of a preparation workflow according to an embodiment of the disclosure.

FIG. 8 is a flowchart of a download workflow according to an embodiment of the disclosure.

FIG. 9 is a flowchart of a verification workflow according to an embodiment of the disclosure.

FIG. 10 is a flowchart of a pre-installation workflow according to an embodiment of the disclosure.

FIG. 11 is a flowchart of an installation workflow according to an embodiment of the disclosure.

FIG. 12 is a flowchart of a post-installation workflow according to an embodiment of the disclosure.

FIG. 13 is a schematic diagram illustrating a firmware upgrade through workflows according to an embodiment of the disclosure.

### DESCRIPTION OF THE EMBODIMENTS

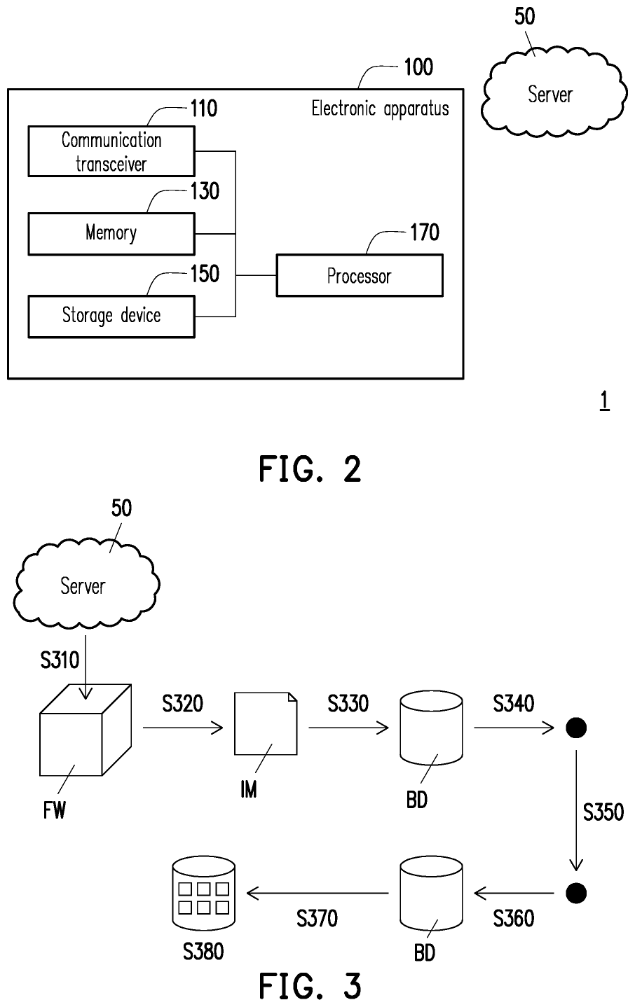

FIG. 2 is a block diagram of elements of a system 1 according to an embodiment of the disclosure. Referring to FIG. 2, the system 1 includes, but not limited to, one or more server 50 and one or more electronic apparatus 100.

The server 50 or the electronic apparatus 100 may be implemented as a smart phone, a tablet computer, a laptop, a desk computer, a server, a network attached storage (NAS) device, a smart household appliance, a voice assistant, or other electronic devices.

The server 50 may serve as a file server or a database and is configured to provide firmware or an operating system with related parameters and/or files. In an embodiment, the server 50 is configured to provide an installation program of the parameters and/or the files, and the detailed function of the installation program is described in the embodiments below.

The electronic apparatus 100 includes, but not limited to, a communication transceiver 110, a memory 130, one or more storage device 150, and a processor 170.

The communication transceiver 110 is, for example, a transceiver (may include, but not limited to, a connection interface, a signal converter, a communication protocol processing chip) supporting a wired network connection such as the Ethernet, an optical network, or a cable. The communication transceiver 110 may also be a transceiver (may include, but not limited to, an element such as an antenna, an analog-to-digital converter, a digital-to-analog converter, or a communication protocol processing chip) supporting a wireless network connection such as Wi-Fi, 4G, 5G, or later generation mobile networks. In an embodiment, the communication transceiver 110 is configured to transmit or receive a signal. In some embodiments, the communication transceiver 110 is configured to be connected to the server 50.

The memory 130 may be a fixed or mobile random access memory (RAM), a read-only memory (ROM), or a flash memory. In an embodiment, the memory 130 is configured to store a program code.

The storage device 150 may be a conventional hard disk drive (HDD), a solid-state drive (SDD), or other similar devices. In an embodiment, the memory 150 is configured to store an operating system. That is, the operating system may be installed in advance in the electronic apparatus 100. For example, the operating system may be Windows, macOS, or Linux.

The processor 170 is coupled to the communication transceiver 110, the memory 130, and the storage device 150. The processor 170 may be may be a central processing unit (CPU), a graphic processing unit (GPU), or other programmable general-purpose or special-purpose microprocessors, a digital signal processor (DSP), a programmable controller, a field programmable gate array (FPGA), an application-specific integrated circuit (ASIC), or other similar devices, or any combination of the above devices. In an embodiment, the processor 170 is configured to execute all or some of the tasks of the dedicated electronic apparatus 100 and may load and execute various software modules, files, and data stored in the memory 130 and/or the storage device 150.

In an embodiment, the one or more electronic apparatus 100 serves as a specialized apparatus for a cloud service, data processing, backup, or other services. However, the disclosure is not intended to limit the purpose of the electronic apparatus. In some embodiments, the server 50 and the electronic apparatus 100 are connected through an internal network, the Internet, or a private network.

The method of the embodiments of the disclosure is described below accompanied with description of various devices, elements, and modules in the system 1. Each step of the method may be adjusted according to actual implementation, and the disclosure is not limited thereto.

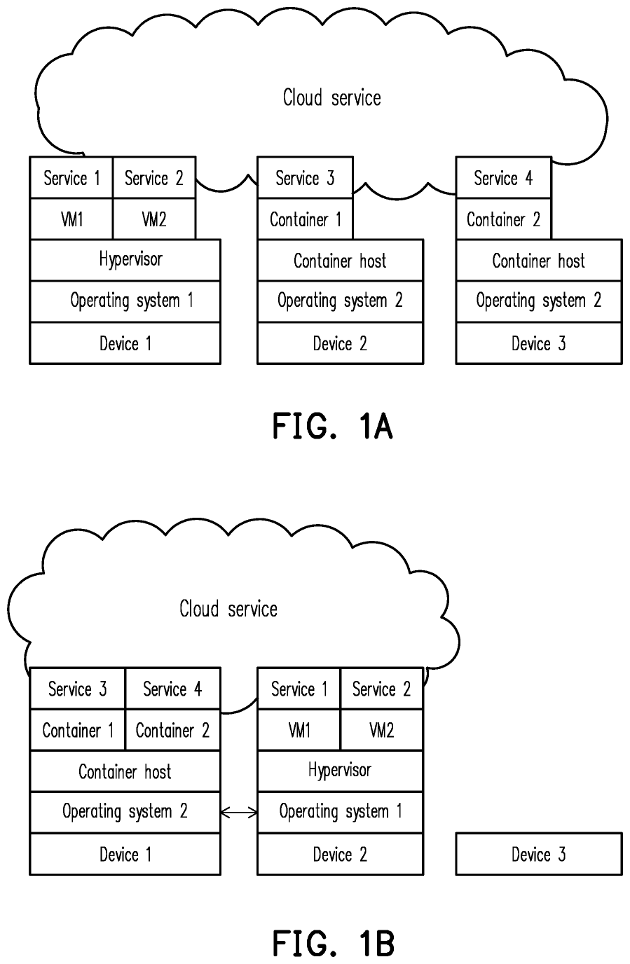

The embodiment of the disclosure provides a concept of software-defined hardware (SDH) to achieve an operating system switch as shown in FIG. 1A to FIG. 1B, thereby increasing the utilization, installation efficiency, and installation flexibility. For example, referring to FIG. 1A and FIG. 1B, compared with FIG. 1A, a deployment of FIG. 1B may achieve a more favorable utilization of a device 1 and a device 2. Furthermore, to achieve specific application, it may be prevented that multiple different types of firmware are provided for one single piece of hardware.

First, an operating system installation or firmware upgrade procedure is introduced. FIG. 3 is a schematic diagram of a firmware FW upgrade procedure according to an embodiment of the disclosure. Referring FIG. 3, it is assumed that a specific version of the firmware FW is released. The firmware FW may be encapsulated with a private header or encrypted. The electronic apparatus 100 may download the firmware FW from the server 50 (step S310). The electronic apparatus 100 fetches and/or decrypts the downloaded firmware FW to obtain an image file IM or other specific private type of file (step S320). The image file IM is written into a boot disk BD (step S330). Before a reboot, the electronic apparatus 100 may execute a self-defined pre-process such as configuring a boot loader, resetting a configuration, and the like (step S340). Next, rebooting the electronic apparatus 100 (step S350). After the reboot, the electronic apparatus 100 is booted with the downloaded firmware FW (step S360) and executes a self-defined establishment process such as downloading and installing software (step S370). After the electronic apparatus 100 initializes a system (step S380), a released operating system may be operated.

Accordingly, operation system installation is a complex and non-standard procedure, and it is difficult to update an operating system to another system. A software component updater of the embodiment of the disclosure may effectively deal with the issue above.

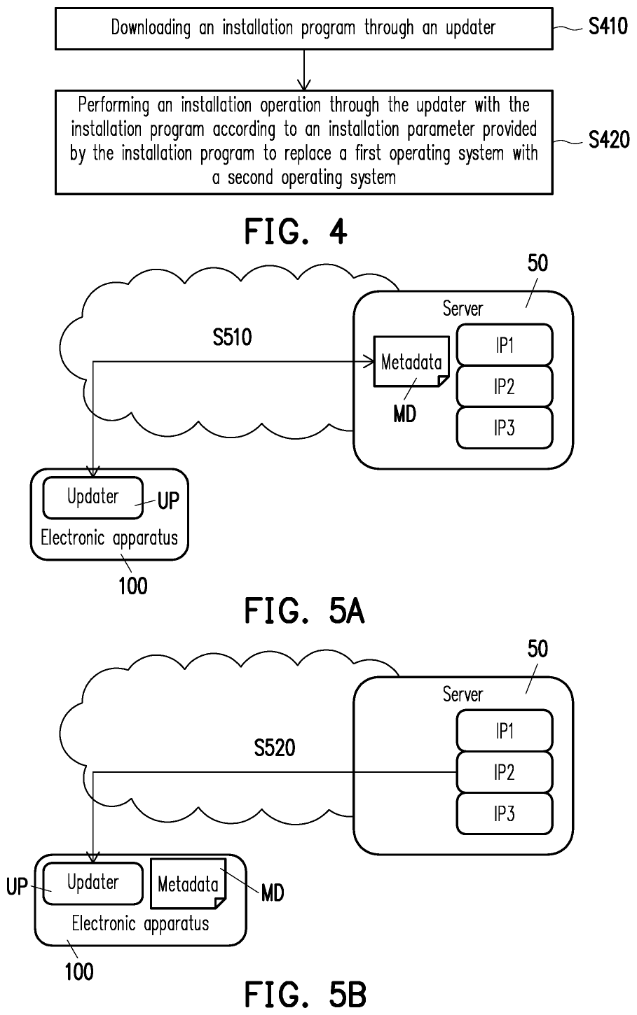

FIG. 4 is a flowchart of a system updating method according to an embodiment of the disclosure. Referring to FIG. 4, the processor 170 of the electronic apparatus 100 downloads an installation program through the updater by using the communication transceiver 110 (step S410). Specifically, if the storage device 150 stores a first operating system (referred to as a host operating system below), the electronic apparatus 100 may operate the host operating system. In the embodiment of the disclosure, the host operating system is expected to be updated or switched into a second operating system (referred to as a new operating system below). Note that the host operating system and the new operating system may be different versions and/or different types. For example, the host operating system is Windows, and the new operating system is Linux. The updater may be a volatile memory (e.g., a ram disk) operated in the host operating system and may provide an (basic) application programing interface (API), a library, or a function for a system switch. The updater may be a software suite established through a shell script. In addition, the installation program includes an installation parameter used for an installation operation of target firmware, and the target firmware includes the new operating system. The installation program may be platform-independent software or cross-platform software established through the shell script, python, or a static link executable machine code.

FIG. 5A and FIG. 5B are schematic diagrams illustrating a download of an installation program according to an embodiment of the disclosure. Referring to FIG. 5A, the processor 170 may obtain one or more firmware option from the server 50 through an updater UP (step S510). Firmware in the firmware option is compatible with hardware of the electronic apparatus 100 and respectively has dedicated installation programs IP1, IP2, and IP3. For example, the firmware option is a mapping table of the hardware type and the compatible firmware/operating system of the electronic apparatus 100 recorded through metadata MD. The mapping table may be JSON text or other text, and which operating system/firmware may be installed in which type of hardware is recorded. The installation programs IP1, IP2, and IP3 are respectively applied to the installation of different operating systems.

Referring to FIG. 5B, it is assumed that the updater UP is based on the metadata MD, and the electronic apparatus is compatible with two operating systems. In response to a triggering behavior (e.g., a selection operation of a user or a predefined automatic behavior), the electronic apparatus 100 may select an operating system, and the updater UP downloads the installation program IP2 of the selected operating system from the server 50 (step S520). For example, download locations (e.g., a URL or a file location of a data system) of the installation programs IP1, IP2, and IP3 are further recorded in the metadata MD so that the updater UP may download the installation program IP2 through the download location of the installation program IP2.

For convenient operation, the electronic apparatus 100 is provided with a safe mode to boot a system on a ramdisk and provide a graphical user interface (GUI) (e.g., a list of compatible operating systems, firmware options, or installation program options).

Referring to FIG. 4, the processor 170 performs the installation operation through the updater with the installation program according to the installation parameter provided by the installation program to replace the first operating system (i.e., the host operating system) with the second operating system (i.e. the new operating system) (step S420). Specifically, the installation program is the installation program of a specified operating system and may be operated in the electronic apparatus 100 to execute an installation procedure of the new operating system by utilizing a function of the host operating system. The installation program may be platform-independent software or an environment supporting multiple host operating systems. Performing the installation operation through the updater with the installation program refers to that the installation program may call one or more function operated in the host operating system and provided by the updater according to a corresponding installation parameter. The installation parameter may be associated with a target location, a file, an order, or an operation and may be changed according to actual requirement, such as, a URL of the target firmware, a target boot disk, unzipping after verification, obtaining device (apparatus) information.

In an embodiment, the installation operation includes one or more workflow. The workflow is, for example, preparation, download, verification, pre-installation, installation, and/or post-installation. The processor 170 may initiate a certain workflow in the workflow to the installation program through the updater. For example, the updater may predefine several workflows and sequentially trigger the installation program to perform an operation of a corresponding workflow through an initiating call according to a workflow order.

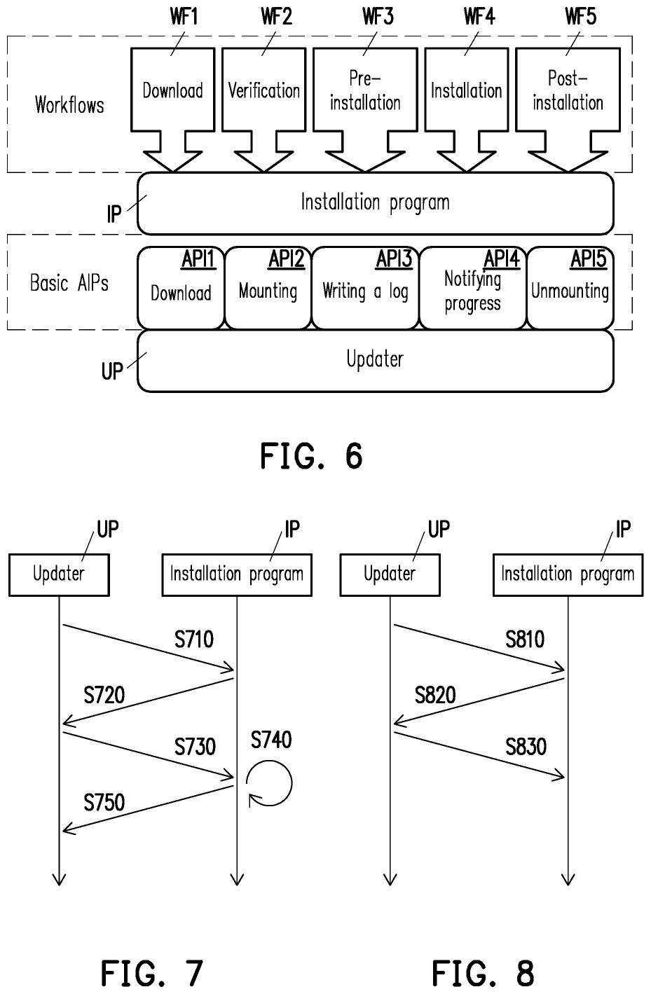

In response to the initiation of the certain workflow, the processor 170 may call an API of a corresponding function according to the installation parameter corresponding to the workflow through the installation program. For example, FIG. 6 is a schematic diagram of workflows and basic application programing interfaces according to an embodiment of the disclosure. Referring to FIG. 6, workflows WF1, WF2, WF3, WF4, and WF5 defined by an installation program IP are respectively download, verification, pre-installation, installation, and post-installation. Application programing interfaces API1, API2, API3, API4, and API5 are respectively APIs for downloading, mounting, writing a log, notifying progress, and unmounting. There are other APIs such as an API for extracting files or an API for obtaining device information. The application programing interfaces provide logic layers for the platform to operate accordingly (e.g., mounting a file system, looking for a boot disk, writing a system log, notifying installation progress, or downloading a file from a specific location). Note that a type and a content of the APIs may be different according to different design requirements, and the disclosure is not limited thereto.

The installation program IP may achieve the installation workflow of the new operating system according to the workflows WF1, WF2, WF3, WF4, and WF5 with the application programing interfaces API1, API2, API3, API4, and API5. The workflows are logic interfaces configured to normalize the update/installation workflow. The installation program IP may sequentially perform the workflows of the installation program IP. According to the above, a manufacturer or a developer only needs to prepare the installation program for the specific operating system to be applied to any compatible hardware devices.

There are many types of the content of the workflows and the associated installation parameters.

For example, FIG. 7 is a flowchart of a preparation workflow according to an embodiment of the disclosure. Referring to FIG. 7, the updater UP initiates a preparation workflow of the installation program IP (step S710). The installation program IP calls an API associated with obtaining device information with respect to the updater UP (step S720). The updater UP may respond to the device information (step S730). The installation program IP verifies the device information (step S740) and calls an API associated with creating a folder with respect to the updater UP (step S750). Note that the application programing interfaces called by the installation program IP may be further associated with a type configured to establish an installation environment, and the disclosure is not limited thereto. Accordingly, an environment corresponding to the new operating system may be established in the electronic apparatus 100.

FIG. 8 is a flowchart of a download workflow according to an embodiment of the disclosure. Referring to FIG. 8, the updater UP calls the installation program IP to start-up the download workflow (step S810). The installation program IP prepares the target firmware location (e.g., a URL) depends on the device information and calls the updater UP through an downloading API (such as the API1 of FIG. 6) for downloading the target firmware (step S820). In addition, the installation program IP has the target firmware location of the target firmware (e.g., a URL). The updater UP may download a target firmware archive according to the URL and respond to the archive location of the target firmware to the installation program IP (step S830).

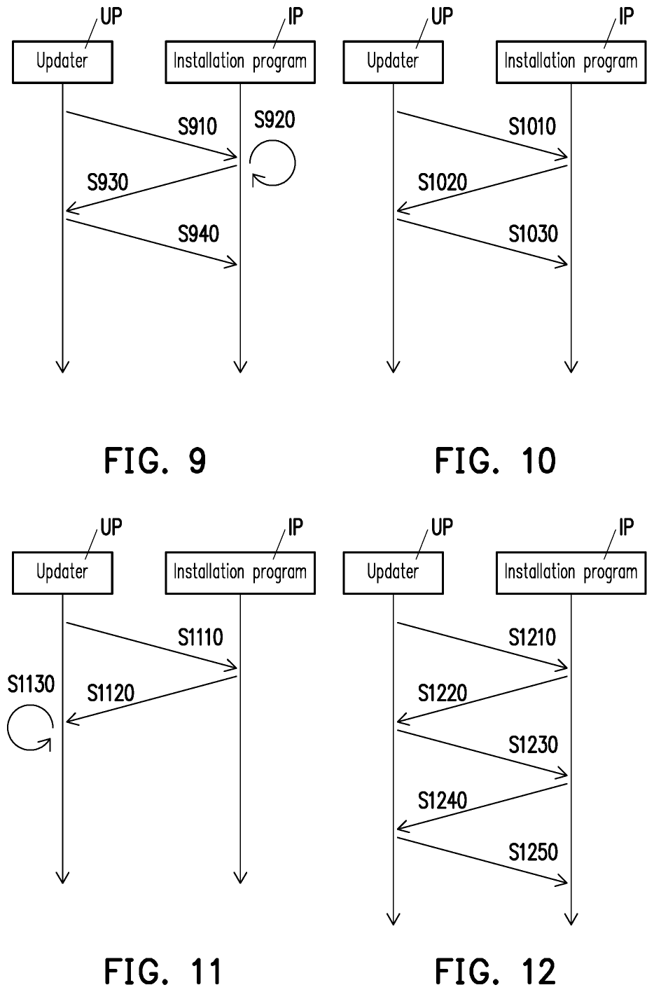

FIG. 9 is a flowchart of a verification workflow according to an embodiment of the disclosure. Referring to FIG. 9, the updater UP initiates a verification workflow to the installation program IP (step S910). The installation program IP checks and decrypts the target firmware archive according to a specific algorithm (step S920). If the check and the decryption succeed and the target firmware archive is zipped, the installation program IP calls an API for extracting the target firmware archive with respect to the updater UP (step S930). The updater UP may respond to an archive location of an unzipped archive of the target firmware (step S940). The target firmware archive can be a compressed file such as zipped file, a 7-zip file or any other kind of compressed file. In some embodiment, the target firmware archive can be a file which is not be compressed. Then, the Step S940 can be removed.

FIG. 10 is a flowchart of a pre-installation workflow according to an embodiment of the disclosure. Referring to FIG. 10, the updater UP initiates a pre-installation workflow to the installation program IP (step S1010). The installation program IP calls an API associated with mounting a boot disk and writing a log with respect to the updater UP (step S1020). The updater UP may respond to a mounting location of the boot disk (step S1030).

FIG. 11 is a flowchart of an installation workflow according to an embodiment of the disclosure. Referring to FIG. 11, the updater UP initiates an installation workflow to the installation program IP (step S1110). The installation program IP calls an API associated with a writing location of an image file or a specific file corresponding to the target firmware and notifying progress with respect to the updater UP (step S1120). The updater UP may write a specified file into the mounting location of the boot disk and report the writing progress of the file (step 1130).

FIG. 12 is a flowchart of a post-installation workflow according to an embodiment of the disclosure. Referring to FIG. 12, the updater UP initiates a post-installation workflow to the installation program IP (step S1210). The installation program IP calls an API associated with unmounting the boot disk with respect to the updater UP (step S1220). The updater UP may respond to an unmounting result (step S1230). Next, the installation program IP calls an API associated with updating a boot loader and writing the log with respect to the updater UP (step S1240). The updater UP may respond to an updated result (step S1250).

Next, the updater UP may reboot the system, and the installation operation of the new operating system is completed. As a result, the host operating system is replaced with the new operating system. The storage device 150 stores the new operating system so that the electronic apparatus 100 may operate the new operating system.

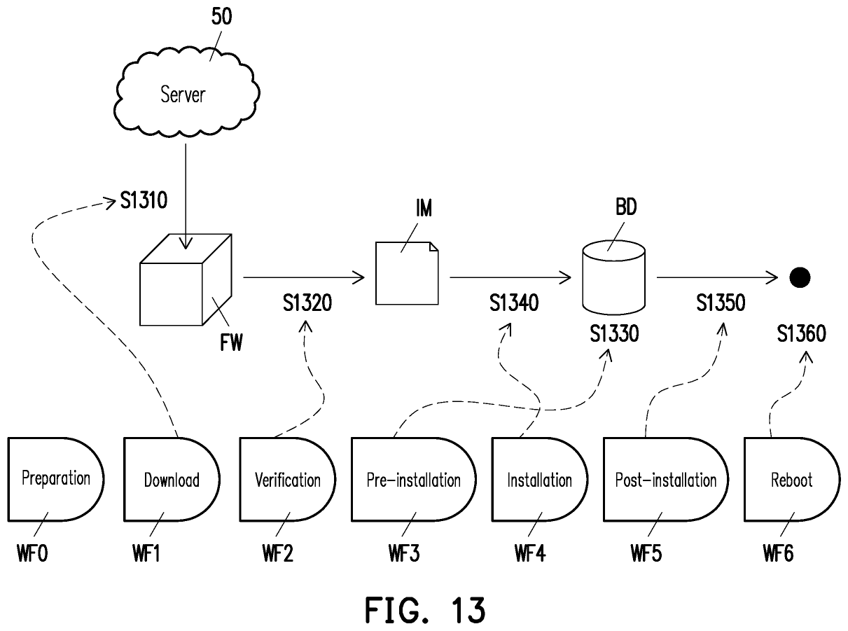

With respect to the workflow of the entire installation operation, FIG. 13 is a schematic diagram illustrating a firmware upgrade through workflows WF0 to WF6 according to an embodiment of the disclosure. Referring to FIG. 13, the preparation workflow WF0 may establish a suitable installation environment as a shown in FIG. 7. The workflow WF1 of the download may download an archive of the target firmware FW from the server 50 or other cloud servers from system provider as shown in FIG. 8 (step S1310). The workflow WF2 of the verification may fetch and decrypt the archive of the target firmware FW as shown in FIG. 9 (step S1320). The workflow WF3 of the pre-installation may mount a boot disk BD to a specific folder as shown in FIG. 10 (step S1330). The workflow WF4 of the installation may install the image file or other file to a mounting location of the boot disk BD as shown in FIG. 11 (step S1340). The workflow WF5 of the post-installation may unmount the boot disk BD and update the boot loader as shown in FIG. 12 (step S1350). The workflow WF6 of the reboot may reboot the system (step S1360).

Note that a type, content, and order of the workflows above may be changed according to actual requirements, and the disclosure is not limited thereto.

In an embodiment, in response to completion of a certain workflow, the processor 170 may transmit a start call of another workflow to the installation program IP through the updater UP. For example, if the workflow WF1 is completed, the updater UP calls the installation program IP to start the operation of the workflow WF2.

It is worth noting that some products (e.g., a router, a switch, a gateway device, an edge computing server, or NAS equipment) may have the same or similar hardware component. The products may operate a specialized operating system due to special purposes. The operating system may be switched easily through the updater in the products.

In summary of the above, in the system updating method and the electronic apparatus of the embodiments of the disclosure, the updater in provided to download and install the new operating system of the target firmware with the installation program. The installation program calls the function provided by the updater in the original host operating system according to the installation parameter corresponding to the workflow. Accordingly, the efficiency and flexibility of switching or updating the operating system may be increased, and the disclosure may be applied to deploy special-purpose service on a device.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A system updating method adapted to an electronic apparatus, wherein the electronic apparatus operates a first operating system, and the system updating method comprises:
downloading an installation program through an updater, wherein the installation program comprises at least one installation parameter used for an installation operation of target firmware, and the target firmware comprises a second operating system; and
performing the installation operation through the updater with the installation program according to the at least one installation parameter provided by the installation program to replace the first operating system with the second operating system, wherein
the installation program calls at least one function operated in the first operating system and provided by the updater according to a corresponding installation parameter.

2. The system updating method according to claim 1, wherein the installation operation comprises at least one workflow, and performing the installation operation through the updater with the installation program comprises:
initiating a first workflow in the at least one workflow to the installation program through the updater; and
in response to an initiation of the first workflow, calling an application programing interface (API) of a corresponding function according to an installation parameter corresponding to the first workflow through the installation program.

3. The system updating method according to claim 2, wherein
in response to the first workflow being a preparation workflow, the installation parameter corresponding to the preparation workflow is associated with apparatus information of the electronic apparatus or establishment of an installation environment; or
in response to the first workflow being a download workflow, the installation parameter corresponding to the download workflow is associated with a download location of the target firmware; or
in response to the first workflow being a verification workflow, the installation parameter corresponding to the verification workflow is associated with decapsulating a file; or
in response to the first workflow being a pre-installation workflow, the installation parameter corresponding to the pre-installation workflow is associated with mounting a boot disk; or
in response to the first workflow being an installation workflow, the installation parameter corresponding to the installation workflow is associated with a writing location of the target firmware; or
in response to the first workflow being a post-installation workflow, the installation parameter corresponding to the post-installation workflow is associated with unmounting the boot disk, writing a log, or setting a bootloader.

4. The system updating method according to claim 2, wherein the at least one workflow further comprises a second workflow, and the system updating method further comprises:
in response to completion of the first workflow, initiating the second workflow to the installation program through the updater.

5. The system updating method according to claim 1, further comprising:
obtaining at least one firmware option through the updater, wherein firmware in the at least one firmware option is compatible with hardware of the electronic apparatus and respectively has a dedicated installation program.

6. An electronic apparatus operating a first operating system and comprising:
a communication transceiver configured to transmit or receive a signal;
a memory configured to store a program code;
at least one storage device configured to store the first operating system; and
a processor coupled to the communication transceiver, the at least one storage device, and the memory and configured to load and execute the program code to:
download an installation program through an updater by using the communication transceiver, wherein the installation program comprises at least one installation parameter used for an installation operation of target firmware, and the target firmware comprises a second operating system; and
perform the installation operation through the updater with the installation program according to the at least one installation parameter provided by the installation program to replace the first operating system stored in the at least one storage device with the second operating system, wherein
the installation program calls at least one function operated in the first operating system and provided by the updater according to a corresponding installation parameter.

7. The electronic apparatus according to claim 6, wherein the installation operation comprises at least one workflow, and the processor is further configured to:
initiating a first workflow in the at least one workflow to the installation program through the updater; and
in response to an initiation of the first workflow, calling an application programing interface (API) of a corresponding function according to an installation parameter corresponding to the first workflow through the installation program.

8. The electronic apparatus according to claim 7, wherein
in response to the first workflow being a preparation workflow, the installation parameter corresponding to the preparation workflow is associated with apparatus information of the electronic apparatus or establishment of an installation environment; or
in response to the first workflow being a download workflow, the installation parameter corresponding to the download workflow is associated with a download location of the target firmware; or
in response to the first workflow being a verification workflow, the installation parameter corresponding to the verification workflow is associated with decapsulating a file; or
in response to the first workflow being a pre-installation workflow, the installation parameter corresponding to the pre-installation workflow is associated with mounting a boot disk; or
in response to the first workflow being an installation workflow, the installation parameter corresponding to the installation workflow is associated with a writing location of the target firmware; or
in response to the first workflow being a post-installation workflow, the installation parameter corresponding to the post-installation workflow is associated with unmounting the boot disk, writing a log, or setting a bootloader.

9. The electronic apparatus according to claim 7, wherein the at least one workflow further comprises a second workflow, and the processor is further configured to:
in response to completion of the first workflow, initiating the second workflow to the installation program through the updater.

10. The electronic apparatus according to claim 6, wherein the processor is further configured to:
obtain at least one firmware option through the updater by using the communication transceiver, wherein firmware in the at least one firmware option is compatible with hardware of the electronic device and respectively has a dedicated installation program.
